(19) United States
(12) Patent Application Publication
(10) Pub. No.: US 2009/0013411 A1
(43) Pub. Date: Jan. 8, 2009

(54) Contents Rights Protecting Method

(75) Inventor: Seung-Jae Lee, Gyeonggi-Do (KR)

Correspondence Address: BIRCH STEWART KOLASCH & BIRCH, PO BOX 747, FALLS CHURCH, VA, 22040-0747, US

(73) Assignee: LG ELECTRONICS INC., Seoul (KR)

(21) Appl. No.: 11/813,771

(22) PCT Filed: Mar. 20, 2006
(86) PCT No.: PCT/KR2006/001013

§ 371 Date: Jul. 12, 2007

(30) Foreign Application Priority Data
Mar. 22, 2005 (KR) 10-2005-0023815

(51) Int. Cl. G06F 21/00

(52) U.S. Cl. 726/26

(57) ABSTRACT

A method for protecting a rights object for a content, wherein when a discard of a rights object with respect to a certain content is requested due to a missing of a terminal which stores the rights object with respect to the content, a rights issuer (RI) receives a confirmation request for whether a certificate has been discarded from the terminal, confirms the certificate discard through an Online Certificate Status Protocol (OCSP) responder, and then notifies the terminal of the certificate discard, and accordingly the terminal confirms the discard of the certificate of the terminal and removes the rights object with respect thereto. In addition, a user who has removed the rights object with respect to the content can continuously use the corresponding content by entirely or partially re-obtaining the rights object with respect to the content from which the rights object has been discarded.

### TECHNICAL FIELD

The present invention relates to a Digital Rights Management (DRM), a method for protecting a rights object with respect to a content stored in a mobile communications terminal.

### BACKGROUND ART

Recently, wired/wireless Internet and network technologies have been developed, and thus industries for providing digital contents have rapidly increased such that contents in a ordinary business transaction which were produced, stored and managed in an analog format are digitalized and accordingly a variety of digitalized contents can be provided.

Digital contents have a great deal of advantages in view of production, processing, and distribution for the existing analog contents. However, such advantages may cause invasion of rights and advantages of original authors with respect to the contents. That is, copy and original are the same as each other. Accordingly, consumers does not strongly intend to buy the original of the contents. Also, the contents may easily be modified and copied without the author's acceptance to be easily peculated. Furthermore, the contents are easily distributed and delivered, and thus illegally copied contents may rapidly spread through a network such as an Internet to thereby be impossible to legally prevent the spread of the illegal copies. Hence, it is necessary to develop techniques for managing and protecting digital rights as well as ensuring the advantages of the digital contents.

A Digital Rights Management (DRM) refers to a system technology for safely protecting and systematically managing rights for digital contents. The DRM is used to provide a prevention of illegal copy for contents, acquisition of rights object for the contents, production and distribution of the contents, and protection and management for series of usage processes. Here, the DRM may be applied to almost all of the digital contents such as text, music, images, games, electronic books, Internet movies, digital broadcasting, databases, and the like.

The DRM uses an encryption technology to convert the digital contents into encrypted data in a packetized format to thereafter permit (accept) an access for the original contents only to users who have done authentication and rights confirmation. When a certain user transmits permitted digital contents to a third party via an Internet or other storage media, the third party may not be permitted to view the encrypted data unless he goes through the authentication and the rights confirmation for the corresponding digital contents, thereby previously preventing the illegal using of the digital contents.

However, in the related art DRM technology, if a user's mobile terminal has a Rights Object (RO) for a certain content, the user can use the corresponding content using his mobile terminal until the RO is discarded. That is, if the user has lost his mobile terminal having the RO for the certain content, it is impossible to prevent the third party who has found the terminal from using the corresponding content.

In addition, in the related art DRM technology, if the user has lost his mobile terminal having the RO for the certain content, the user must re-purchase the RO for the corresponding content in order to use the content.

### DISCLOSURE OF THE INVENTION

Therefore, it is an object of the present invention to provide a method for protecting a rights object for a content in which when a user has lost his terminal in which a Rights Object (RO) for a certain content is stored, the RO stored in the terminal is discarded to thus prevent a third party who picks up the terminal from using the content.

It is another object of the present invention to provide a method for protecting a rights object for a content in which after a user discards an RO for a content stored in his terminal having lost, the user can reuse the RO for the content using his another terminal or the lost terminal which the user has re-acquired.

To achieve these objects, there is provided a method for protecting a rights object for a content comprising: receiving an instruction for a certificate confirmation by a terminal having a Rights Object (RO) for a certain content; confirming by the terminal whether the certificate of the terminal has been discarded in response to the instruction for the certificate confirmation; and removing, by the terminal, the RO for the content stored therein when it is confirmed that the certificate has been discarded.

According to another embodiment of the present invention, there is provided a method for protecting an RO for a content comprising: sending an instruction for a certificate confirmation from a Rights Issuer (RI) to a terminal having an RO for a content; confirming whether the certificate of the terminal has been discarded in response to a confirmation request with respect to the discard of the certificate of the terminal in accordance with the instruction for the certificate confirmation; and sending a result of the certificate confirmation from the RI to the terminal.

To achieve these objects, there is also provided a method for protecting a rights object for a content in a system for providing a terminal with a content and a rights object for the content, the method comprising: receiving a request for discarding a certificate of a certain terminal in a Certificate Authority (CA) and then discarding the corresponding certificate: receiving a request for discarding a Rights Object (RO) with respect to the content by a Rights Issuer (RI); instructing, by the RI, the terminal to request for a confirmation of whether the certificate has been discarded; sending a validate certificate request message from the terminal to the RI; sending a validate certificate response message including a result that the certificate has been discarded from the RI to the terminal in response to the received validate certificate request message; and removing the RI for the content stored in the terminal.

According to another embodiment of the present invention, there is provided a method for protecting a rights object for a content comprising: when a certificate and a rights object with respect to a content for a certain terminal are requested to be discarded, discarding the certificate by a certificate authority and confirming by the terminal whether the certificate thereof has been discarded; removing the rights object with respect to the content by the terminal which has confirmed the discard of the certificate thereof; requesting, by the terminal, the rights object for the content from a rights issuer when a certain user intends to use the content of the terminal; confirming, by the rights issuer through an online certificate status protocol responder, that the certificate of the terminal has been discarded; informing the terminal, by the rights issuer, of an unsuccessful acquaintance of the rights object for the content; and outputting an impossibility of using the content and restricting the using of the content by the terminal.

According to still another embodiment of the present invention, there is provided a method for protecting a rights object for a content comprising: discarding a certificate by a certificate authority and confirming, by a lost terminal through a rights issuer, whether the certificate thereof has been discarded or not; when the certificate of the lost terminal has been discarded, storing a rights object for a content of the lost terminal by the rights issuer; removing the rights object of the content by the lost terminal which has confirmed the discard of the certificate; when a user requests for the rights object for the content used in the lost terminal, receiving in the rights issuer a command for registering a terminal designated by the user; performing a device registration for the terminal by the rights issuer having received the command; when there does not exist the rights object for the content in the terminal, acquiring, by the terminal, the rights object for the content from the rights issuer; and storing the rights object for the content and executing the corresponding content by the terminal.

### BRIEF DESCRIPTION OF THE DRAWINGS

FIG. 1 is a block diagram illustrating a structure of a system for implementing a method for protecting a rights object for a content according to the present invention;

FIG. 2 is a flowchart illustrating a method for protecting a rights object with respect to a content according to the present invention;

FIG. 3 is an exemplary view illustrating an embodiment of a ROAP trigger according to the present invention;

FIGS. 4a and 4b are views illustrating structures of DRM content formats;

FIG. 5 is a signal flow chart illustrating a method for discarding a rights object with respect to a content of a lost terminal according to the present invention;

FIG. 6 is a signal flow chart illustrating a process for restricting a usage of a content of a lost terminal according to the present invention; and

FIG. 7 is a signal flow chart illustrating a method for reusing a content of which rights object has been discarded according to the present invention.

### MODES FOR CARRYING OUT THE PREFERRED EMBODIMENTS

Reference will now be made in detail to the preferred embodiments of the present invention, examples of which are illustrated in the accompanying drawings. It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

Hereinafter, an explanation will now be given for embodiments of a method for protecting a rights object for a content according to the present invention with reference to the attached drawings.

The present invention relates to a method for protecting a Rights Object (RO) for a content with respect to a lost terminal by which when having lost a terminal storing an RO for a certain content, the RO stored in the lost terminal is discarded to thus prevent a third party who has picked the lost terminal up from using the content.

When a terminal having an RO for a certain content has been lost and accordingly a request is made (sent) to discard the RO for the content, a Rights Issuer (RI) having received the request instructs the lost terminal to request a certificate confirmation. The lost terminal having received the instruction makes a request from the RI for validating a validity for its certificate. The RI having received the validation request confirms the validity for the certificate of the terminal through an Online Certificate Status Protocol (OCSP) Responder, and informs the terminal of the result of the confirmation. Here, when the certificate of the terminal has been discarded, the terminal itself removes all of the ROs associated with the content.

In the present invention, in addition, when requesting for discarding the RO for the content stored in the lost terminal, a Certificate Authority (CA) is requested to discard the certificate for the lost terminal.

Furthermore, in the present invention, a user who has lost his terminal, from which the RO for the content stored in the terminal has been discarded, hands over the RO for the content into his new terminal to thusly acquire the RO or a part of the RO, thereby continuously using the corresponding content. Or, the user who has regained his lost terminal reacquires the RO or a part of the RO for the content of which the RO has been discarded, thereby continuously using the corresponding content.

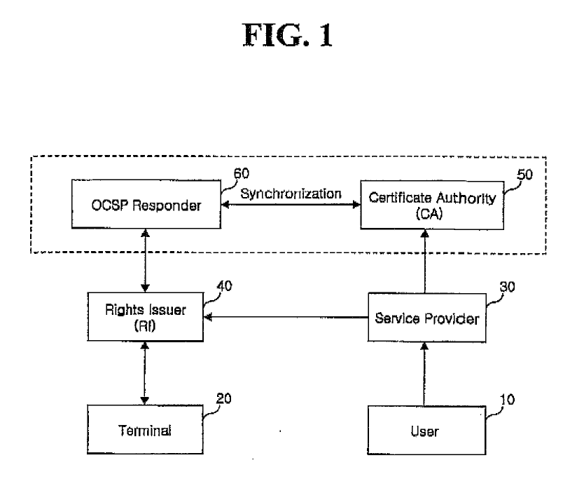

FIG. 1 is a block diagram illustrating a structure of a system for implementing a method for protecting an RO of a content according to the present invention. The system may include a user 10, a terminal 20 having a Rights Object (RO) for a certain content, a service provider 30 for providing a communication network (especially, a wireless network service), a Rights Issuer (RI) 40 for issuing the RO for the content, a Certificate Authority (CA) 50 for performing a management for a certificate such as generating, discarding and updating of the certificate with respect to the terminal 20, and a Online Certificate Status Protocol (OCSP) responder 60 for validating whether the certificate for the terminal 20 is available.

The terminal 20 uses a Rights Object Acquisition Protocol (ROAP) to request the RO from the RI 40 and obtains the RO. Here, the ROAP is generated by a ROAP trigger transmitted from the RI 40.

The RI 40 performs a ROAP transaction with the terminal 20. Upon intending to issue the RO to the terminal 20, the RI 40 uses the OCSP to confirm through the OCSP responder 60 whether the certificate for the terminal 20 is available. Here, the OCSP may include an OCSP request message which the RI 40 sends to the OCSP responder 60, and an OCSP response message which the OCSP responder 60 sends to the RI 40 in response to the request message.

The OCSP responder 60 uses the certificate or a certificate ID of the terminal 20 which has been sent from the terminal 20 via the RI 40 to verify whether the certificate of the terminal 20 designated by the RI 40, and then sends the result of the verification to the RI 40 using the OCSP response message. The OCSP responder 60 receives information related to the certificate from the CA 50 periodically or in real time to thereby update the information about the certificate. Here, the OCSP responder 60 and the CA 50 may be the same entity, or independent entities, respectively.

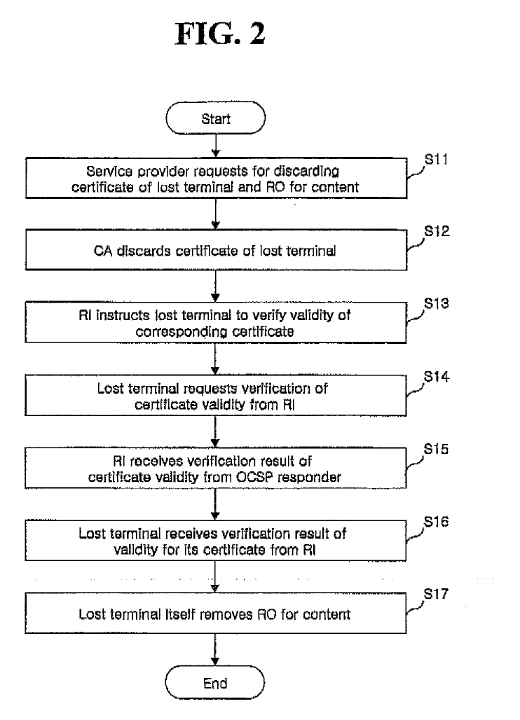

FIG. 2 is a flow chart illustrating a method for protecting an RO for a content according to the present invention, which will now be explained based upon the system illustrated in FIG. 1.

First, it is assumed that the user 10 has lost his terminal 20 which stores an RO for a certain content and thereafter notifies the service provider 30 of the loss of the terminal 20.

The service provider 30 makes a request for discarding both a certificate with respect to the lost terminal 20 and the RO for the content (S11).

The CA 50 having received the request for discarding the certificate for the lost terminal 20 discards the certificate for the corresponding terminal 20 (S12), and the RI 40 having received the request for discarding the RO for the content indicates the lost terminal 20 to request for confirming whether the certificate for the lost terminal 20 is available (S13).

The lost terminal 20, which has received the indication for requesting the confirmation for whether the certificate is valid, requests from the RI 40 to verify whether the certificate thereof is valid (S14). The RI 40 having received the request receives the result of the verification of the validity with respect to the certificate of the lost terminal 20 from the OCSP responder 60 by use of the OCSP (S15), and then sends a response protocol including the result of the verification to the lost terminal 20.

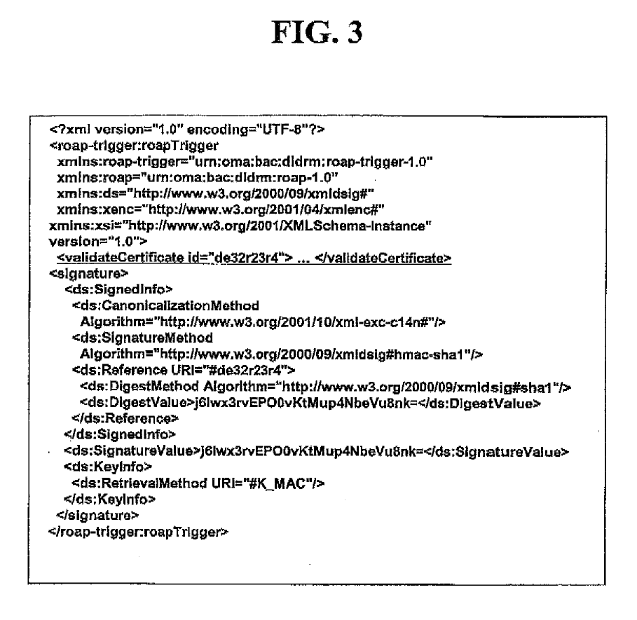

Here, in order to indicate (instruct) the lost terminal 20 to request for confirming whether the certificate of the lost terminal 20 itself is valid, the RI 40 sends a message to the lost terminal 20. The message, as illustrated in FIG. 3, may be sent in a format of ROAP trigger, or may include a protocol for requesting from the RI 40 to verify the validity for the certificate of the lost terminal itself 20. The ROAP trigger, the protocol for requesting the verification of the certificate validity, and the response protocol including the result of the verification will be explained hereafter.

The lost terminal 20 receives the response protocol from the RI 40 (S16), and confirms the result of the verification that its certificate is not valid to thereafter remove the RO for the content immediately (S17).

In order to implement the method for protecting the RO for the content, the present invention defines a new message (protocol) which is send between the RI 40 and the terminal 20.

First, a Validate Certificate Protocol which the lost terminal 20 sends and receives to/from the RI 40 in order to verify the validity of its certificate is newly defined.

The Validate Certificate Protocol may include a Validate Certificate Request Message which the terminal 20 sends to the RI 40 to request the verification of the validity with respect to its certificate, and a Validate Certificate Response Message which the RI 40 sends to the terminal 20 to send the result of the verification of the validity with respect to the certificate of the terminal 20.

Second, an Online Certificate Status Protocol (OCSP) trigger which the RI 40 sends to the lost terminal 20 to generate the Validate Certificate Protocol is newly defined. The OCSP trigger is transferred to the terminal 20 in a manner of a server push (especially, a WAP push).

FIG. 3 illustrates an embodiment in which the ROAP trigger is represented in a manner of an Extensible Markup Language (XML). The ROAP trigger may include <validateCertificate> element and <signature> element in <roapTrigger> element. The <validateCertificate> element denotes a certificate confirmation related element and may include a terminal certificate or a terminal certificate ID.

The terminal 20 having received the ROAP trigger verifies a digital signature using information included in the <signature> element. If the digital signature is available, the terminal 20 sends the Validate Certificate Request Message to the RI 40 using information included in the <validateCertificate> element.

While, the ROAP trigger sent from the RI 40 to the terminal 20 may send to the terminal 20 a <validateCertificate> element which does not include a certificate of a certain terminal or a terminal certificate ID. The terminal 20 which receives the <validateCertificate> element sends the Validate Certificate Request Message to the RI 40 for a certificate (or certificates) within the corresponding terminal 20.

The RI 40 having received the Validate Certificate Request Message receives the result of the verification of the certificate validity from the OCSP responder 60, and then sends the result of the verification to the terminal 20 by including it in the Validate Certificate Response Message.

Upon receiving the Validate Certificate Response Message which includes the result of the verification indicating that the certificate has been discarded, the terminal 20 itself removes all of the ROs related to the discarded certificate.

In a typical Digital Rights Management (DRM), on the other side, contents and ROs related to the contents may be sent to the terminal by using a combined delivery method or a separated delivery method.

The combined delivery denotes a method for delivering both a content and an RO with respect to the corresponding content using one message, while the separated delivery denotes a method for delivering a content and an RO for the corresponding content separately. The content and the RO in the combined delivery and the content in the separated delivery may all be sent in a manner of a DRM Content Format (DCF).

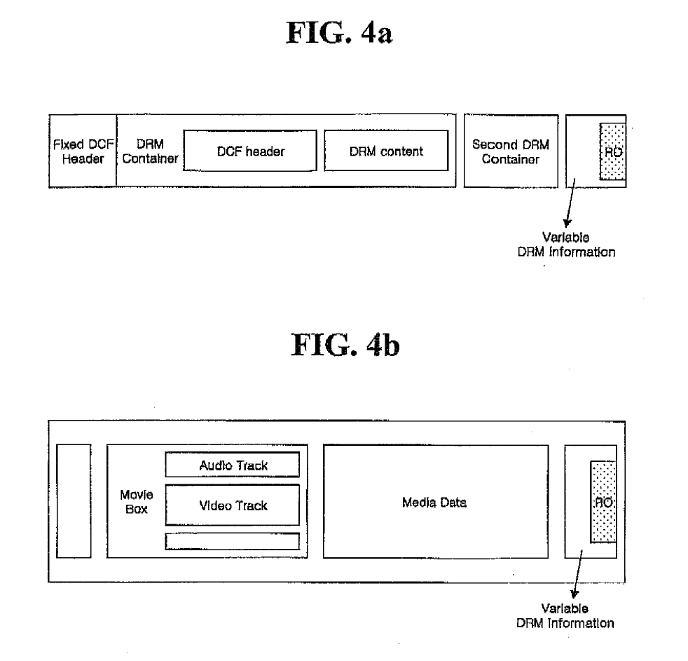

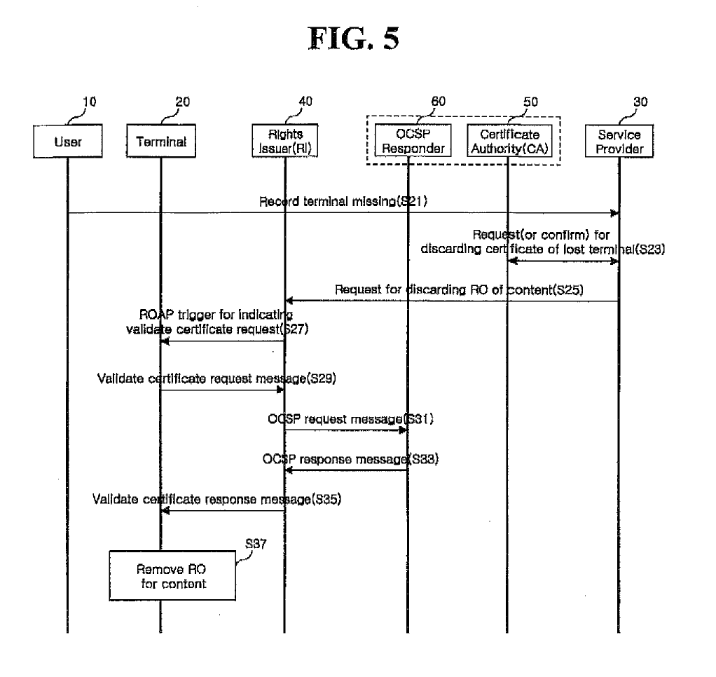

FIGS. 4a and 4b are views illustrating DRM content formats used in the combined delivery. FIG. 4a is a view illustrating a structure of a Discrete Media Profile (DMP) which is used to protect and package discrete media, and FIG. 4b is a view illustrating a structure of a continuous media profile which is used to protect and package continuous media.

The discrete media denote contents without including a time element such as still images or web pages, and the continuous media denote contents based upon time such as video or audio. Here, the continuous media are protected as a separated profile, and thus the continuous media profile may also be referred to as a Packetized DRM Content Format (PDCF). As illustrated in FIGS. 4a and 4b, an RO may additionally be included in the DRM Content Format (DCF).

In the present invention, upon removing an RO for a content received according to the combined delivery method, the terminal 20 only removes the RO included in the DCF itself or a portion of variable DRM information of the DCF. Upon removing an RO for a content received according to the separated delivery method, the terminal 20 removes at least the RO stored in its memory.

FIG. 5 is a signal flow chart illustrating an embodiment of a method for protecting an RO for a content according to the present invention, namely, an embodiment of a process for restricting (constraining) the using of a content stored in a terminal 20 by another user when a user 10 has lost the terminal 20.

When the user 10 has lost the terminal 20 which stores an RO of a certain content, the user 10 informs the service provider 30 that the terminal 20 has been lost (S21). Here, the user registers information that the terminal has been lost to a customer center of the service provider 30 using a telephone or through an Internet.

The service provider 30 requests the discard of the certificate with respect to the lost terminal 20 from the CA 50 (S23), and requests the discard of the RO for the content which the lost terminal 20 used from the RI 40 (S25). Here, the service provider 30 informs the CA 50 of a certificate ID of the lost terminal 20, and informs the RI 40 of a user ID or a terminal ID.

The RI 40 having received the RO discard request sends a ROAP trigger for generating a Validate Certificate Request Message to the lost terminal 20 in a manner of a WAP push (S27), and the lost terminal 20 sends the Validate Certificate Request Message to the RI 40 to verify whether its certificate is valid (S29). Here, the ROAP trigger may include the <validateCertificate> element which includes a certificate of a terminal or a certificate ID of the terminal.

The RI 40 having received the Validate Certificate Request Message sends an OCSP Request Message to the OCSP responder 60 to request the verification of whether the certificate of the terminal 20 is available (S31). The OCSP responder 60 sends the result of the verification with respect to the certificate validity to the RI 40 using an OCSP Response Message (S33). Here, the OCSP responder 60 receives information related to the certificate from the CA 50 periodically or in real time, thereby matching the information related to the terminal certificate with certificate information stored in the CA 50.

The RI 40 having received the OCSP Response Message sends a Validate Certificate Response Message including the result of the verification to the terminal 20 (S35). The terminal 20 confirms that its certificate has been discarded through the Validate Certificate Response Message, and thereafter immediately deletes the RO with respect to the content (S37).

In case where the certificate of the terminal 20 has been discarded, the RI 40 stores items related to authority and constraint by interconnecting with an ID of the corresponding terminal 20 and a user ID, the items being included in the RO with respect to the content used by the corresponding terminal 20. Thereafter, when the same user requests for the RO with respect to the content, the RI 40 sends a new RO including the items related to the stored authorities and restrictions. When the user who has lost his terminal 20 registers a new terminal in the service provider 30 and requests for the RO with respect to the content used by the lost terminal, the RI 40 hands over and sends a new RO to a newly registered terminal, the new RO including the items related to the authority and constraint of the RO for the content.

Here, in the RO for the content used by the terminal 20, items related to constraint which are changed by the user's use (e.g., a constraint for totally used time, the number of times for being used, etc.) may be sent from the terminal 20 to the RI 40 by use of a certain protocol when discarding the certificate of the terminal 20 and then be stored in the RI 40. In addition, in the RO for the content used by the terminal 20, items which are not changed by the user's use (e.g., the authority, a constraint of days to be used, etc.) may be previously stored in the RI 40 when sending the RO to the terminal 20 by use of the ROAP.

A process for reusing a content for which an RO is removed will be explained in detail later.

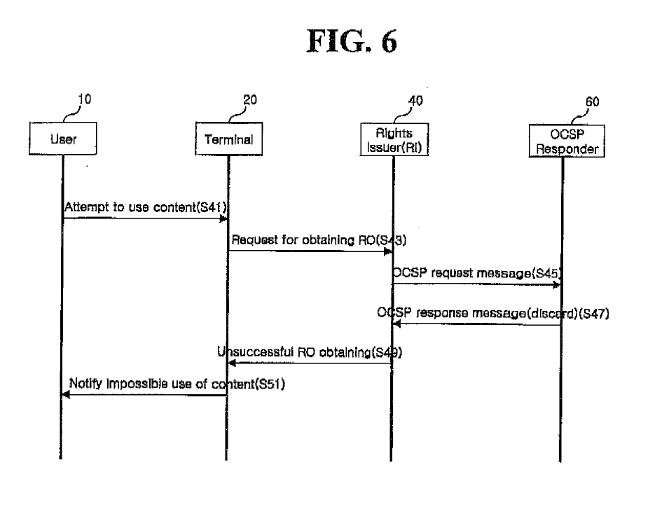

FIG. 6 is a signal flow chart illustrating a process for restricting the use of a content in case where a third party intends to use the content by use of the lost terminal 20, wherein the lost terminal 20 is a terminal of which certificate has been discarded and from which an RO for a stored content has been removed.

When a certain user 11, namely, a third party who has picked up the lost terminal 20, tries to use the content stored in the terminal 20 (S41), a DRM agent of the terminal 20 confirms non-existence of an RO for the content. The DRM agent of the terminal 20 then requests an RO from the RI 40 (S43). Here, the terminal 20 sends an RO Request Message to the RI 40.

The RI 40 requests a verification of a certificate validity of the terminal 20 from the OCSP responder 60 (i.e., sends an OCSP Request to the OCSP responder 60) (S45). The OCSP responder 60 notifies the RI 40 through an OCSP response message that the certificate of the terminal 20 has been discarded (S47).

The RI 40 informs the terminal 20 through an RO response message that the RO for the content can not be obtained (S49). The terminal 20 outputs an announcement message to thus allow the current user 11 to recognize that the content can not be used accordingly (S51).

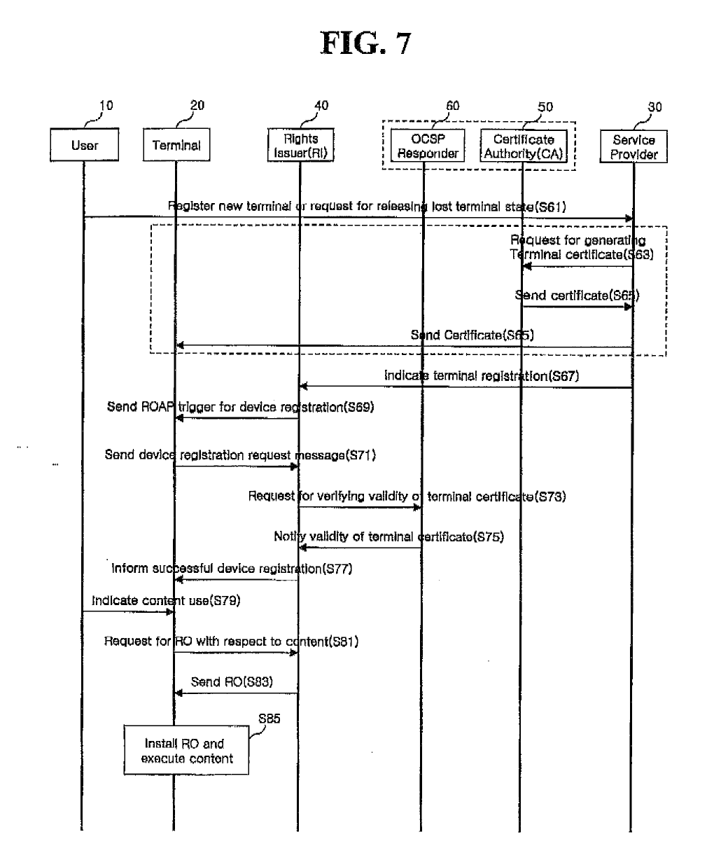

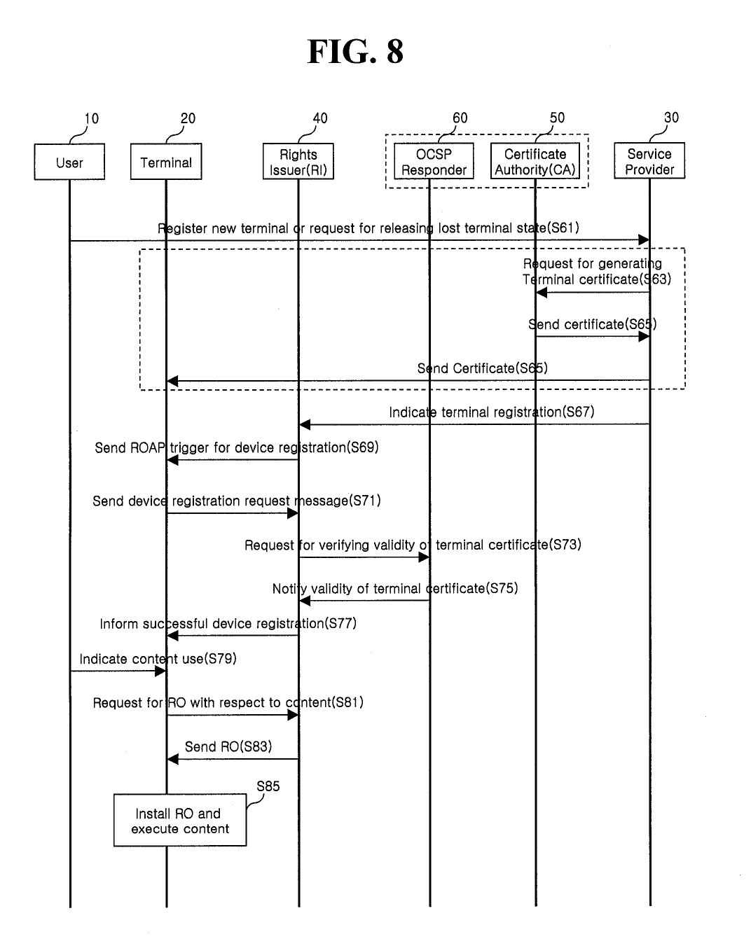

FIG. 7 is a signal flow chart illustrating a method for using a content, which a user who has lost his terminal used using the lost terminal, in a new terminal or in the lost terminal after regaining, wherein a certificate for the lost terminal has been discarded and the RO for the content has been removed.

First, explanation will now be given for a method such that a user who has regained his lost terminal 20 can continuously use the content which used in the terminal 20.

The user 10 requests a release of a lost state with respect to the terminal 20 from the service provider 30 (S61). The service provider 30 cancels the missing report for the lost terminal 20 via a process for a user identification, and thereafter requests from the CA 50 to regenerate a certificate of the terminal 20 (S63). It is impossible to recover the discarded certificate, and accordingly the CA 50 should regenerate the certificate of the terminal 20.

The CA 50 having received the request sends a certificate containing its signature to the service provider 30, and the service provider 30 sends the certificate to the terminal 20 (S65).

The service provider 30 indicates (instructs) the RI 40 to register the terminal 20 (S67). The RI 40 sends the ROAP trigger for a device registration to the terminal 20, thereby instructing the terminal 20 to perform the device registration process (S69).

The terminal 20 having received the ROAP trigger requests the device registration from the RI 40 (S71). The RI 40 sends an OCSP Request Message to the OCSP responder 60 in order to request for a verification of whether the certificate of the corresponding terminal 20 is available (S73).

The OCSP responder 60 informs the RI 40 that the certificate of the terminal 20 is available through an OCSP Response Message (S75). The RI 40 notifies the terminal 20 that the device has successfully been registered (S77).

When the user 10 tries to use a content stored in his terminal 20 (S79), the terminal 20 confirms that it does not have an RO with respect to the content, and then requests the RO with respect to the content from the RI 40 via a ROAP protocol (S81).

The RI 40 having received the request sends the RO with respect to the content to the terminal 20 (S83), and the terminal 20 installs the RO sent and then executes the corresponding content (S85). Here, the RO sent from the RI 40 to the terminal 20 may denote an RO including the authority and constraint in the ROs which have previously been stored when discarding the RO with respect to the content, or may denote a newly-allocated RO.

In general, an RO contains an encryption key for decoding an encoded content. In case that an existing content is not removed from a terminal but maintained therein and thereby the encryption key is not changed, the RI 40 sends an RO which uses the encryption key as it is among the stored ROs. In the meantime, in case that the terminal 20 receives a new content containing a changed encryption key, the RI 40 sends the RO containing the changed encryption key to the terminal 20.

Second, explanation will now be made for a method in which a user who has lost his terminal uses a content, which was used in his lost terminal, in his new terminal.

When the user 10 registers the new terminal 20 in the service provider 30 (S61), the service provider 30 requests a certificate of the new terminal 20 from the CA 50 (S63), and receives the requested certificate from the CA 50 to then send it to the terminal 20 (S65). Here, when the new terminal itself contains the certificate, the certificate request (S63) and the certificate sending (S65) may not be performed.

The service provider 30 indicates the RI 40 to register the terminal 20 (S67). Here, the service provider 30 sends a use ID and/or a new terminal ID to the RI 40, and requests from the RI 40 to transfer to the new terminal 20 the RO containing the authority and constraint among ROs with respect to the content which the user 10 had. The RI 40 having received the request finds the RO with respect to the content which is stored by being interconnected with the user ID to thereafter change the lost terminal ID into the new terminal ID.

Afterwards, the device registration process for the new terminal and the content RO obtaining process are the same as the process for registering the device in order to continuously use a content for which the RO is removed and the process for obtaining the RO with respect to the content, whereby a detailed explanation therefor will be omitted.

### EFFECT OF THE INVENTION

As described above, the method for protecting the RO with respect to the content can effectively be achieved such that when missing a terminal in which an RO with respect to a certain content is stored, the use of the content by another user who finds the lost terminal can be prevented by allowing the lost terminal to discard the RO stored therein according to a user's request.

In addition, the method for protecting the RO with respect to the content can effectively prevent contents or resources stored in the lost terminal from being opened to another user (i.e. a third party) rather than the original user of the corresponding terminal.

Also, the method for protecting the RO with respect to the content can effectively improve the user's satisfaction for the RO with respect to the content by allowing the user who has discarded the RO with respect to the content stored in the lost terminal to reuse the RO with respect to the content entirely or partially.

1. A method for protecting a rights object with respect to a content comprising:
receiving, in a terminal having a rights object with respect to a certain content, an instruction for confirming a certificate;
confirming, by the terminal, whether the certificate thereof has been discarded in response to the instruction for confirming the certificate; and
when it is confirmed that the certificate has been discarded, removing, by the terminal, the rights object with respect to the content stored therein.

2. The method of claim 1, wherein the confirming of whether the certificate has been discarded comprises:
requesting, by the terminal, for confirming whether the certificate has been discarded from a rights issuer;
confirming whether the certificate has been discarded, by the rights issuer through an Online Certificate Status Protocol (OCSP) responder; and
receiving, in the terminal, the result of the confirmation via the rights issuer.

3. The method of claim 1, wherein in the step of receiving the instruction for the certificate confirmation, a Rights Object Acquisition Protocol (ROAP) trigger for confirming the certificate is received, the ROAP trigger having sent from the rights issuer to the terminal.

4. The method of claim 3, wherein the ROAP trigger includes a ‘validateCertificate’ element.

5. The method of claim 4, wherein the ‘validateCertificate’ element includes the terminal certificate or a terminal certificate ID.

6. The method of claim 2, wherein in the step of requesting for confirming whether the certificate has been discarded, the terminal sends a Validate Certificate Request to the rights issuer.

7. The method of claim 2, wherein in the step of receiving the confirmation result of the certificate, the terminal sends to the rights issuer a Validate Certificate Response, which includes the confirmation result of whether the certificate has been discarded.

8. The method of claim 2, further comprising:
when the certificate has been discarded, storing, by the rights issuer, the rights object for the content with respect to the terminal by interconnecting the rights object with at least one or more of a terminal ID and a user ID.

9. A method for protecting a rights object with respect to a content comprising:
sending an instruction for a certificate confirmation from a rights issuer to a terminal having a rights object with respect to a content;
confirming whether the certificate of the terminal has been discarded in response to the request for the confirmation of whether the certificate of the terminal has been discarded according to the instruction for the certificate confirmation; and
sending the result of the certificate confirmation from the rights issuer to the terminal.

10. The method of claim 9, further comprising:
when the certificate has been discarded, storing, by the rights issuer, the rights object for the content with respect to the terminal by interconnecting the rights object with at least one or more of a terminal ID and a user ID.

11. The method of claim 9, further comprising:
removing the rights object with respect to the content stored in the terminal which has received the result of the certificate discard.

12. The method of claim 9, wherein in the step of sending the instruction for the certificate confirmation, the rights issuer sends a Rights Object Acquisition Protocol (ROAP) trigger for confirming the certificate to the terminal.

13. The method of claim 12, wherein the ROAP trigger includes a ‘validateCertificate’ element.

14. The method of claim 13, wherein the ‘validateCertificate’ element includes the terminal certificate or a terminal certificate ID.

15. The method of claim 9, wherein the confirmation request for whether the certificate has been discarded denotes a Validate Certificate Request.

16. The method of claim 9, wherein the result of the certificate confirmation denotes a Validate Certificate Response.

17. The method of claim 9, wherein the confirming of whether the certificate of the terminal has been discarded comprises:
requesting for verifying the certificate from an Online Certificate Status Protocol (OCSP) responder, by the rights issuer having received the confirmation request for whether the certificate has been discarded; and
receiving a response with respect to the verification request from the OCSP responder.

18. A method for protecting a rights object with respect to a content in a system for providing a terminal with a content and a rights object for the content, the method comprising:
receiving a request for discarding a certificate of a certain terminal, in a authority server (CA), and then discarding the corresponding certificate;
receiving a request for discarding the rights object with respect to the content in a rights issuer;
instructing, by the rights issuer, the terminal to request for confirming whether the certificate thereof has been discarded;
sending a Validate Certificate Request Message from the terminal to the rights issuer;
sending a Validate Certificate Response Message including the result of the successful certificate discard from the rights issuer to the terminal in response to the received Validate Certificate Request Message; and
removing the stored rights object with respect to the content by the terminal.

19. The method of claim 18, wherein in the step of sending the Validate Certificate Response Message, the rights issuer confirms the certificate discard of the terminal through an Online Certificate Status Protocol (OCSP) responder.

20. The method of claim 19, wherein the OCSP responder receives information related to the certificate from the authority server periodically or in real time.

21. The method of claim 18, wherein the request for discarding the rights object by the rights issuer includes at least one or more of a user ID and a terminal ID.

22. The method of claim 18, wherein the instruction related to the request for the confirmation of the certificate discard sent from the rights issuer is a Rights Object Acquisition Protocol (ROAP) trigger which generates the Validate Certificate Request Message.

23. The method of claim 22, wherein the ROAP trigger includes a ‘validateCertificate’ element.

24. The method of claim 23, wherein the ‘validateCertificate’ element includes the terminal certificate or a terminal certificate ID.

25. The method of claim 18, wherein the Validate Certificate Request Message and the Validate Certificate Response Message are validate certificate protocols which are transmitted and received between the terminal and the rights issuer in order for the terminal itself to request for verifying the validity of the certificate and to receive a response to the verification.

26. The method of claim 19, wherein confirming whether the certificate of the terminal has been discarded comprises:
sending an Online Certificate Status Protocol (OCSP) Request Message from the rights issuer to the OCSP responder; and
when the certificate has been discarded, sending an OCSP Response Message including the result of the certificate discard from the OCSP responder to the rights issuer.

27. The method of claim 18, wherein sending the Validate Certificate Response Message further comprises:
storing, by the rights issuer, the rights object for the content with respect to the terminal by interconnecting with at least one or more of a terminal ID and a user ID.

28. A method for protecting a rights object with respect to a content comprising:
when receiving a request for discarding a certificate of a certain terminal and a rights object, discarding the certificate by a certificate authority and confirming by the terminal whether the certificate thereof has been discarded;
removing the rights object by the terminal which has confirmed the discard of the certificate;
when a certain user tries to use a content of the terminal, requesting, by the terminal, for a rights object with respect to the content from a rights issuer;
confirming whether the terminal certificate has been discarded, by the rights issuer through an Online Certificate Status Protocol (OCSP) responder;
informing, by the rights issuer, the terminal of failure of acquiring the rights object with respect to the content; and
outputting a message informing that the content is not able to be used, by the terminal, and constraining the use of the content.

29. The method of claim 28, wherein determining whether the certificate has been discarded comprises:
instructing a certificate confirmation to the terminal by the rights issuer;
sending a Validate Certificate Request Message from the terminal to the rights issuer;
confirming the discard of the certificate from the OSCP responder by the rights issuer; and
sending the result that the certificate has been discarded from the rights issuer to the terminal by use of a Validate Certificate Response Message.

30. The method of claim 29, further comprising:
when the certificate has been discarded, storing, by the rights issuer, the rights object for the content with respect to the terminal by interconnecting the rights object with at least one or more of a terminal ID and a user ID.

31. The method of claim 28, wherein in the step of requesting for the rights object with respect to the content, the terminal sends a rights object request (RO Request) to the rights issuer.

32. The method of claim 28, wherein in the step of informing the failure of acquiring the rights object, the rights issuer sends a rights object response (RO Response) which includes information related to the failure of acquiring the rights object to the terminal.

33. A method for protecting a rights object with respect to a content comprising:
when a discard of a certificate with respect to a lost terminal and rights object with respect to a content, discarding the certificate by a certificate authority and confirming by the lost terminal whether the certificate thereof has been discarded through a rights issuer;
when the certificate of the lost terminal has been discarded, storing the rights object with respect to the content of the lost terminal by the rights issuer;
removing the rights object by the lost terminal having confirmed the discard of the certificate;
when a user requests for a rights object with respect to a content used in the lost terminal, receiving a registration command with respect to a terminal designated by the user;
performing a device registration for the terminal by the rights issuer having received the command;
when the rights object does not exist in the terminal, obtaining the rights object for the content from the rights issuer by the terminal; and
storing the rights object for the content, by the terminal, and executing the corresponding content.

34. The method of claim 33, wherein the rights object with respect to the content of the lost terminal is stored in the rights issuer by being interconnected with at least one or more of a user ID and a lost terminal ID.

35. The method of claim 33, wherein the terminal designated by the user denotes a new terminal or the lost terminal.

36. The method of claim 33, wherein receiving the terminal registration command when the designated terminal is the new terminal comprises:
receiving the terminal registration command including at least one or more of the user ID and the new terminal ID by the rights issuer; and
transferring the rights object with respect to the content of the lost terminal having stored from the rights issuer to the new terminal.

37. The method of claim 36, wherein in the step of transferring the rights object for the content, the lost terminal ID interconnected with the rights object is changed into the new terminal ID.

38. The method of claim 36, further comprising:
confirming whether the new terminal has a certificate.

39. The method of claim 38, wherein confirming the existence of the certificate comprises:
when the certificate of the new terminal does not exist, receiving a certificate generation request for the new terminal by the certificate authority; and
sending a generated certificate from the certificate authority to the new terminal.

40. The method of claim 33, wherein receiving the terminal registration command when the designated terminal is the lost terminal comprises:
receiving certificate regeneration request for the lost terminal in the certificate authority; and
sending a regenerated certificate from the certificate authority to the lost terminal.

41. The method of claim 33, wherein performing the device registration for the terminal comprises:
instructing the terminal to request for a device registration by the rights issuer;
receiving a device registration request message from the terminal by the rights issuer;
confirming whether the certificate of the terminal has been discarded by the rights issuer through an Online Certificate Status Protocol (OCSP) responder; and
informing the terminal of the successful device registration by the rights issuer.

42. The method of claim 33, wherein acquiring the rights object for the content comprises:
sending a rights object request message from the terminal to the rights issuer; and
receiving a rights object response message from the rights issuer.
